(19) United States
(12) Patent Application Publication
(10) Pub. No.: US 2015/0071071 A1
(43) Pub. Date: Mar. 12, 2015

(54) LOAD BALANCING BETWEEN NODES PROCESSING DATA AND BACKHAUL UTILIZATION

(71) Applicant: Cluster Wireless, LLC., San Diego, CA (US)

(72) Inventors: Robbin David Hughes, Plano, TX (US); Prem Jothipragasam Kumar, San Diego, CA (US); Thomas O'Neill, La Jolla, CA (US); Ramesh Rajasekharan, Chennai (IN)

(73) Assignee: Cluster Wireless, LLC, San Diego, CA (US)

(21) Appl. No.: 14/024,478

(22) Filed: Sep. 11, 2013

(51) Int. Cl. H04L 12/803

(52) U.S. Cl. CPC H04L 47/125
USPC 370/235

(57) ABSTRACT

The proposed embodiment provides a method and system for load balancing between one or more nodes and a plurality of backhaul links over a communication network. The method includes computing processing data of the node(s) using parameters associated with the node, and computing backhaul link loading data using parameters associated with the plurality of backhaul links. Further, the method includes analyzing the processing data and the backhaul link loading data using one or more rules, and determining whether load balancing is required in accordance to the analysis. Furthermore, the method includes performing one or more actions in the communication network to load balance between the node and the plurality of backhaul links in response to determining that the load balancing is required.

### TECHNICAL FIELD

The present embodiment relates to load balancing and, more particularly, to a mechanism for load balancing between nodes processing and backhaul utilization in a communication network.

### BACKGROUND

Modern machine to machine (M2M) communications has expanded beyond one-to-one connection and changed into a system of M2M networks. Each M2M network system can typically include a plurality of electronic devices such as base stations, sensors, traffic concentrators, and the like communicating with a central server using a plurality of backhaul communication links providing different network paths to the server. In such M2M systems, the electronic device configuration is generally performed from a backhaul server which handles transport of raw electronic device data from the electronic device to the server. Load balancing in such M2M network systems involves significant challenges.

Many different systems and methods are proposed to perform load balancing in a communication network. One mechanism includes a back-end server used to collect raw data from sensors throughout the network and transfer it to central server for further processing. Signal processing (such as ranging and statistical analysis) is typically performed in the back-end server for load balancing, or in some limited fashion in the sensor itself with a fixed proportion at each point. In another mechanism, the load balancing is achieved by implementing policy based routing in each device in the network. In yet another mechanism, a load balancer is configured as a proxy server that receives a packet of information from each device in the network and performs analysis on the packet to select backhaul links and then forwards the packet to the selected server. In yet another mechanism, the load balancing is performed based on a load metric. Although the load metric is used in order to determine trigger time of the load balancing algorithm, a fluctuation of the load metric according to time is inevitable because an amount of demand for user data traffic and a capacity of the radio resources may fluctuate in real-time. Further in real-time, the amount of processing required by each device in the network may vary depending on various dynamic characteristics such as the amount of data, trigger levels, sample frequency, processor loading, transfer rate, congestion, security, communication channels, as well as varying backhaul link quality, transient loading, and the like, due to which the conventional system may be inefficient in accurately balancing load in the network. A little consideration for these dynamically varying characteristics can be used to accurately perform load balancing through the network.

### BRIEF DESCRIPTION OF THE FIGURES

The embodiments herein will be better understood from the following detailed description with reference to the drawings, in which:

FIG. 1 is a block diagram that illustrates generally, among other things, a high level architecture of a system, according to embodiments described herein;

FIG. 2 expands features and functions of the system as described in the FIG. 1, according to embodiments described herein;

FIG. 3 is a sequence diagram that illustrates operations performed by the server as described in the FIGS. 1 and 2, according to embodiments disclosed herein; and

FIG. 4 illustrates a flow chart illustrating a method for balancing load over between the nodes and the plurality of backhaul links over a communication network, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Prior to describing the present embodiment in detail, it is useful to provide definitions for key terms and concepts used herein. Unless defined otherwise, all technical and scientific terms used herein have the same meaning as commonly understood by one of ordinary skill in the art.

The term “load balancing” used in this disclosure refers to achieving the balance of loads by controlling the loads between nodes processing data and the plurality of backhaul links utilization over communication network.

The term “node” used in this disclosure corresponds to an inclusive word having a meaning of a domain in which a source is independently operated by a server. It is noted that the term “node” may be used as a term having a meaning of a “Base Station (BS)” or “sensor”.

The term “backhaul” used in this disclosure corresponds to an intermediary between a server and one or more nodes, such as to include intelligence in the network to efficiently process the data over communication network.

The embodiments herein disclose a method and system for load balancing between one or more nodes and a plurality of backhaul links over a communication network. The communication network is served by the plurality of backhaul links between the one or more nodes and a server. The server can be configured to compute processing data of a node using one or more parameters associated with the node. In an embodiment, the one or more parameters associated with the node described herein can include for example, but not limited to, node processing data, node characteristics, node transfer rate, processor loading, node near-by nodes, communication channel, profile data, node preferences, usage data, range, speed, bandwidth, security data, congestion, and the like. The server can be configured to compute backhaul link loading data using one or more parameter associated with the plurality of backhaul links. In an embodiment, the one or more parameters associated with the backhaul link described herein can include for example, but not limited to, link utilization data, link quality data, type of link data, link transfer rate, security data, congestion on link, and the like. One or more rules can be used to analyze the processing data and the backhaul link loading data. The server can be configured to determine whether load balancing is required in accordance to the analysis. Further, the server can be configured to perform one or more actions in the communication network to load balance between the one or more nodes and the plurality of backhaul links in response to determining that the load balancing is required.

The proposed system and method is simple, reliable, and robust for load balancing between the one or more nodes and the plurality of backhaul links over the communication network. The proposed system and method can be used to provide better end-to-end utilization of the network resources as signal processing (which could compress down the amount of data points being transported up the links from sensors to back to the server) is moved down closer to where the raw data stream is originated. The signal processing can even be pulled up into the server if requirements of the signal processing are exceeding the capabilities of the nodes, such as to efficiently perform the load balancing throughout the communication network. Further, the proposed system allows the nodes to dynamically switch and utilize the good quality backhaul links such that more data could be passed directly to the server. The system can be used to provide an optimal balance between the data processed in the nodes and the data being sent through the backhaul to the server. Furthermore, the use of different parameters can enable accurate load balancing based on the requirements of each node throughout the communication network. The system and method can be used to effectively balance the load between the one or more nodes and the plurality of backhaul links by selecting optimal action based in accordance to the rules. Furthermore, the system and method can be used to provide seamless balancing between the nodes and the backhaul links (by allowing the nodes to dynamically switch among the most optimal backhaul links) without interrupting the service provided by the server. A complete optimal solution can be offered to the communication network by providing such seamless balancing over the communication network. Furthermore, the proposed system and method can be implemented on the existing infrastructure and may not require extensive set-up or instrumentation.

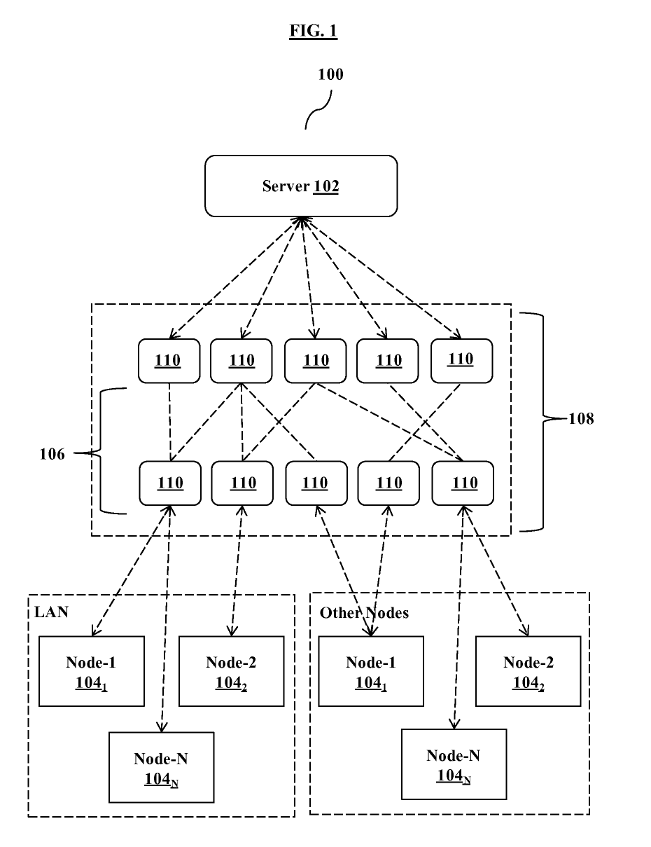

Referring now to the drawings, and more particularly to FIGS. 1 through 4, where similar reference characters denote corresponding features consistently throughout the figures, there are shown embodiments.

FIG. 1 is a block diagram that illustrates generally, among other things, a high level architecture of a system 100, according to embodiments described herein. The system 100 can include a server 102 communicating among one or more nodes 104_{1-N} (hereafter referred as node(s) 104) using a plurality of backhaul links 106 over a communication network.

In an embodiment, the server 102 described herein can be for example, but not limited to, gateway device, router, hub, computer, laptop, wireless electronic device, personal digital assistance, smart phone, and the like. The controller 104 can be configured to include interfaces to connect with the devices 106 throughout the network 102. The server 102 can be capable of coordinating the processing data received from the nodes 104 through the backhaul links 106. In an embodiment, the communication network described herein can be for example, but not limited to, machine to machine (M2M) network, wireless network, wire line network, public network such as the Internet, private network, global system for mobile communication network (GSM), general packet radio network (GPRS), local area network (LAN), wide area network (WAN), metropolitan area network (MAN), cellular network, public switched telephone network (PSTN), personal area network, a combination thereof, or any other network. The communication network can be served by the plurality of backhaul links 106 between the server 102 and the one or more nodes 104. The term “backhaul” used herein refers to an intermediary between the server 102 and the nodes 104, such as to include intelligence in the network to efficiently process the data over the communication network. The communication network can be served by a plurality of network paths 108 between the server 102 and the one or more nodes 104. Each network path 108 can include the plurality of respective backhaul links 106, controlled by various control nodes 110, defining an intermediate backhaul network to allow the transfer of information between the server 102 and the nodes 104.

In an embodiment, the nodes 104 described herein can be for example, but not limited to, sensor, traffic concentrators, gateway device, base stations, access point, Node B, evolved Node B (eNB), femtocell access point, picocell access point, microcell access point, macro access point, relay node, transmission controller, router, hub, computer, laptop, wireless electronic device, personal digital assistance, smart phone, and the like. The nodes 104 can be configured to include appropriate interfaces to directly or indirectly communicate with the server 102 using the appropriate backhaul links 106 over the network 102. The nodes 104 can be configured to use the backhaul links 106 to transfer the raw data to the server 102.

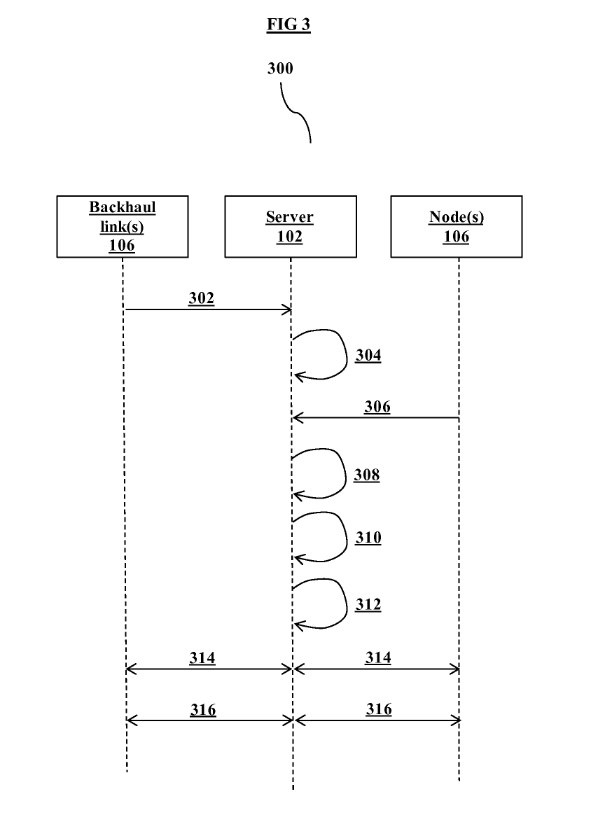

Further, as amount of demand for the node data traffic and the capacity of the radio resources are fluctuated according to time, the server 102 can be configured to dynamically associate the backhaul links 106 with each node 104 based on the requirements of the node 104 and the capability of each backhaul link 106, such as to efficiently balance the load over the communication network. The server 102 can be configured to individually associate the backhaul links 106 with the network paths 108. The usage of the backhaul links 106 by the nodes 104 can be determined by the server 102 based on different parameters such as for example, but not limited to, node pre-processing data, node characteristics, node transfer rate, processor loading, node near-by nodes, communication channel, profile data, node preferences, usage data, range, speed, bandwidth, security data, congestion, link utilization data, link quality data, type of link data, link transfer rate, and the like. The server 102 can be configured to receive the overall communication network information including various nodes 104 associated with the respective backhaul links 106 in a variety of ways, such as for example, but not limited to, by accessing a database, by receiving input from a user, by polling elements, by communicating with the network paths 108, and the like. Furthermore, the various operations performed by the server 102 are described in conjunction with the FIG. 3.

Though the FIG. 1 shows the server 102 centrally communicating with the nodes 104 using the backhaul links 106 over the communication network but, it is to be understood that another embodiment is not limited thereto. Further, the system 102 can include any number of servers, nodes, and backhaul links communication in any other way along with other hardware or software components. For example, the component can be, but not limited to, a process running in the controller or processor, an object, an executable process, a thread of execution, a program, and/or a computer. By way of illustration, both an application running on a server and the server itself can be a component. Furthermore, the system 100 can include a computer-related entity, such as but not limited to a controller, computer program, firmware, or a combination thereof, along with sufficient interfaces and application software's that enables communication throughout the system 100. The system 100 can be configured to include various techniques and technologies to enable wireless communication throughout the system. The techniques and technologies described herein can include for example, but not limited to, Code Division Multiple Access (CDMA), Wideband CDMA (WCDMA), Time Division Multiple Access (TDMA), Frequency Division Multiple Access (FDMA), Orthogonal Frequency-Division Multiple Access (OFDMA), Single Carrier FDMA (SC-FDMA), Global System for Mobile Communications (GSM), Universal Mobile Telecommunication System (UMTS), 3rd Generation Partnership Project (3GPP) Long Term Evolution (LTE), Ultra Mobile Broadband (UMB), Institute of Electrical and Electronics Engineers (IEEE) 802.11 (Wi-Fi), IEEE 802.16 (Wi-Max), IEEE 802.20, and the like.

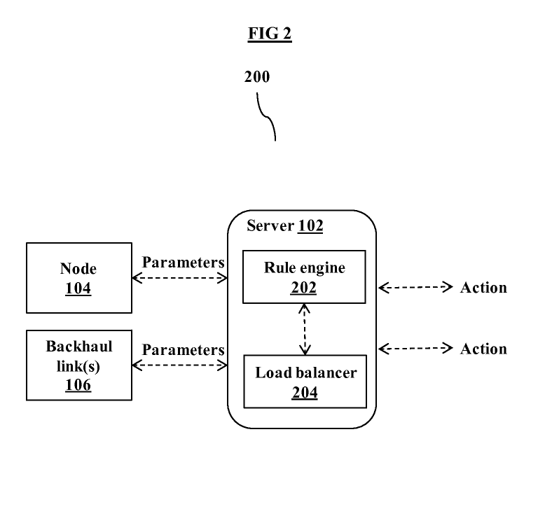

FIG. 2 expands features and functions of the system 100 as described in the FIG. 1, according to embodiments described herein. In an embodiment, the server 102 can be configured to compute processing data of node(s) 104 using one or more parameters associated with the node 104. Each node 104 in the communication network can be associated with a number of corresponding parameters that can be tuned to affect the load balance, performance and responsiveness of the system 100. In an embodiment, the one or more parameters associated with the node 104 described herein can include for example, but not limited to, node pre-processing data, node characteristics, node transfer rate, processor loading, node near-by nodes, communication channel, profile data, node preferences, usage data, range, speed, bandwidth, security data, congestion, and the like.

Further, in an example, the node characteristic parameter described herein can include, but not limited to, battery level, routing information, service cost, device mobility, and the like. In an example, communication channel parameter described herein can include, but not limited to, the channel quality derived from derived Signal-to-Noise Ratio (SNR), different types of communications link such as Bluetooth, ZigBee, Wi-Fi, P2P, ultra-wideband, and the like used by the node. In an example, the profile parameter described herein can include but not limited to, mode in which the device is running such as power saving mode, idle mode, sleep mode, and the like.

In an embodiment, the server 102 can be configured to compute backhaul link loading data using one or more parameter associated with the plurality of backhaul links 106. Each backhaul link 106 in the communication network can be associated with a number of corresponding parameters that can be tuned to affect the load balance, performance, and responsiveness of the system 100. In an embodiment, the one or more parameters associated with the backhaul link 106 described herein can include for example, but not limited to, link utilization data, link quality data, type of link data, link transfer rate, security data, congestion on link, and the like. Any changes in these parameters associated with the node 1041 and the backhaul links 106 can affect the overall load balance, performance, sensitivity, cost, and reliability of the communication network. Furthermore, the use of different parameters can enable accurate load balancing based on the requirements of each node and backhaul link throughout the communication network.

In an embodiment, one or more rules can be used to analyze the pre-processing data and the backhaul link loading data. The server 102 can be configured to include a rule engine 202 to analyze the pre-processing data and the backhaul link loading data. In an embodiment, the rule engine 202 can be configure to execute the one or more rules on each parameter associated with the node 104 and the backhaul link 106, such as to determine whether the load balancing is required between the node 104 and the plurality of backhaul links 106. The rule engine 202 can be configured to dynamically construct a load balancing rule using the parameters associated with the node 104 and the backhaul link 106. In an embodiment the rules described herein can be for example, but not limited to, unidirectional rules, bidirectional rules, generalized rules including multi-way rules, rules among clusters, rules for a M2M system, rules among collections of parameters, rules among collections of backhaul links, rules with weight factors, rules with priorities, un-weighted and un-prioritized rules, and the like. Unlike conventional systems, the dynamic construction of rules using the real-time parameters associated with the nodes 104 and the backhaul link 106 can be used to accurately perform the load balancing in accordance to the requirements of the nodes 104. The rule engine 202 can be configured to run or execute the rule on the pre-processing data and the backhaul link loading data, such to perform a load balancing analysis. An exemplary pseudo code for performing a load balancing analysis based on the rules are as follows:

Load Balancing Rule-1 - (sensor rate=250kbps, processing data=1 GB,
associated link=backhaul_link_port_226):
If (sensor rate<500kbps, processing data>500 MB,
backhaul_link_port_226_quality=poor)
{
Switch_ backhaul_link= backhaul_link_port_230
return payload_data
}
Load Balancing Rule-2 - (sensor rate=22kbps, processing_data=1 GB,
associated link=backhaul_link_port_130):
If (sensor rate<10kbps, processing data>500 MB) and if (backhaul_link_
port=130, backhaul_link_loading=True)
{
Switch_backhaul_link= backhaul_link_port_142
return payload_data
}

In an example, if the parameters associated with a node are sensor rate=5 kbps, processing data=1 GB, and associated link=backhaul_link_port_226 then the rule engine 202 can be configured to construct a load balancing analysis rule (such as rule-1) by executing various combinations of the parameters. The rule engine 202 can be configured to execute the rule on the processing data and the backhaul link loading data, such as to determine whether the load balancing is required between the node 104 and the plurality of backhaul links 106. For example, the rule engine 202 can execute the rule-1 to analyze the processing data and the backhaul link loading data and determines that a load balancing is required as the quality of the “backhaul_link_port_230” is poor to handle the “1 GB” of data on the sensor rate of “250 kbps”. Similarly, the rule engine 202 can be configured to take various other parameters associated with the backhaul link 106 and the node 104 to perform the load balancing analysis. For example as shown in the rule-2, the rule engine may check the backhaul_link_loading status. If the backhaul_link_loading status is “true” then the server 102 may determine that a load balancing is required as transferring data using a link which is still loading may result into a delay or a loss of the data.

Further, the server 102 can be configured to include a load balancer 204 to perform one or more actions in the communication network, such as to balance the load between the node 104 and the plurality of backhaul links 106. In embodiment, the one or more actions described herein can include for example, but, not limited to, switch among the plurality of backhaul links 106 in accordance to the rules, return payload data from the node 104 by un-processed signals at each node, and the like. The sever 102 can be used to effectively balance the load between the nodes 104 and the plurality of backhaul links 106 by selecting optimal action based in accordance to the rules, such as to achieve an optimal balance between the data processed in the nodes 104 and the data being sent through the backhaul links 106 to the server 102. In an embodiment, the signal processing which could compress down the amount of data points being transported up the links from sensors to back to the server can be moved down closer to where the raw data stream is originating from. The signal processing can even be pulled up into the server 102 if requirements of the signal processing are exceeding the capabilities of the nodes 104, such as to efficiently perform the load balancing throughout the communication network.

Furthermore, the rule engine 202 and the load balancer 104 can be cooperatively implemented in the server 102 using a computer program, a load balancing algorithm, a software module, a hardware module, or a combination thereof. Furthermore, the rules and other elements described with respect to the FIG. 2 are only for illustrative purpose and do not limit the scope of the embodiment. In real-time, the rules can be implemented or executed in various forms using any combination of parameters associated with the nodes 104 and the backhaul links 106, without departing from the scope of the embodiment. Furthermore, the rules can be derived from, for example, but not limited to, automatic generation machine learning, automatic generation using a generic algorithm, automatic generation using a neutral network, automatic generation using a rule inference system, data mining, generation using characteristics of a M2M network, and the like.

FIG. 3 is a sequence diagram that illustrates operations 300 performed by the server 102 as described in the FIGS. 1 and 2, according to embodiments disclosed herein. In an embodiment, at 302, the server 102 can be configured to receive one or more parameters associated with the node 104. Each node 104 in the communication network can be associated with a number of corresponding parameters that can be tuned to affect the load balance, performance and responsiveness of the system 100. In an embodiment, the one or more parameters associated with the node 104 can include for example, but not limited to, node pre-processing data, node characteristics, node transfer rate, processor loading, node near-by nodes, communication channel, profile data, node preferences, usage data, range, speed, bandwidth, security data, congestion, and the like. Any changes in these parameters can affect the load balance, performance, sensitivity, cost, and reliability of the system 100. In an embodiment, at 304, the server 102 can be configured to compute processing data of node(s) 104 using the one or more parameters associated with the node 104. The processing data described herein can include the overall raw data transferred by the nodes 104 using the backhaul links 106 to the server 102.

In an embodiment, at 306, the server 102 can be configured to receive one or more parameter associated with the plurality of backhaul links 106. Each backhaul link 106 in the communication network can be associated with a number of corresponding parameters that can be tuned to affect the load balance, performance, and responsiveness of the system 100. In an embodiment, the one or more parameters associated with the backhaul link 106 can include for example, but not limited to, link utilization data, link quality data, type of link data, link transfer rate, security data, congestion on link, and the like. Any changes in these parameters can affect the overall load balance, performance, sensitivity, cost, and reliability of the system 100. In an embodiment, at 308, the server 102 can be configured to compute backhaul link loading data using one or more parameter associated with the plurality of backhaul links 106. The backhaul link loading data includes data related to for example, the backhaul links utilization, quality, pre-processing, loading and the like data.

In an embodiment, at 310, the server 102 can be configured to analyze the processing data and the backhaul link loading data using one or more rules. In an example, the server 102 can be configured to use the rule engine 202 to construct a load balancing analysis rule, such as to determine whether the load balancing is required between the node 104 and the plurality of backhaul links 106. The rule engine 202 can be configured to dynamically construct the load balancing rule using the parameters associated with the node 104 and the backhaul link 106. The rule engine 202 can be configured to run or execute the load balancing rule on the processing data and the backhaul link loading data, such to perform a load balancing analysis.

In an embodiment, at 312, the sever 102 can be configured to determine whether the load balancing is required between the node 104 and the plurality of backhaul links 106. In an embodiment, at 314, the server 102 can be configured to perform one or more actions in the communication network to balance the load between the node 104 and the plurality of backhaul links 106 in response to determining that the load balancing is required. The one or more actions described herein can include for example, but, not limited to, switch among the plurality of backhaul links 106 in accordance to the rules, return payload data from the node 104 by un-processed signals at each node, and the like. In an example, the server 102 uses a load balancer 204 to perform one or more actions in the communication network, such as to balance the load between the node 104 and the plurality of backhaul links 106. The sever 102 can be used to effectively balance the load between the nodes 104 and the plurality of backhaul links 106 by selecting optimal action based in accordance to the rules, such as to achieve an optimal balance between the data processed in the nodes 104 and the data being sent through the backhaul links 106 to the server 102. Furthermore, the server 102 allows the nodes 104 to dynamically switch and utilize the good quality backhaul links 106 such that more data could be passed directly to the server 102.

In an embodiment, at 316, the server 102 can be configured to frequently monitor the parameters associated with the nodes 104 and the backhaul links 106 to automatically load balance between the between the node 104 and the plurality of backhaul links 106 over the communication network. The frequent monitoring of the parameters can allow the server 102 to provide seamless, optimal, personalized, reliable, uninterrupted, and enhanced load balancing service in the communication network. The server 102 can be configured to dynamically provide seamless balancing between the nodes 104 and the backhaul links 106 by allowing the nodes to dynamically switch among the most optimal backhaul links 106 without interrupting the service provided by the server 102. Furthermore, the signal processing can even be pulled up into the server if requirements of the signal processing are exceeding the capabilities of the nodes, such as to efficiently perform the load balancing throughout the communication network.

Furthermore, in an embodiment, the server 102 can be configured to dynamically detect and update the applications associated with each node in the communication network. The server 102 can be configured to automatically install and update the existing applications on the nodes 104. In an example, the existing application may be edited or new instructions may be inserted in the existing application program to update the existing applications. Further, the server 102 can automatically restart the node to activate the new updates or the server 102 may configure the updates in way to get activated automatically after installation. In another embodiment, the server 102 can be configured to dynamically detect and upgrade the applications associated with each node in the communication network. The server 102 can be configured to automatically install different versions of application on the nodes 104. The new version application can be installed as a standalone application thereby retaining the existing applications unchanged. The new version application can be considered as a latest version and included in trend of application versions available on each node.

The various operations described with respect to the FIG. 3 can be performed in the order presented, or simultaneously, or parallel, or in any different order. The operations described herein are only for illustrative purpose and do not limit the scope of the embodiment. Further, in some embodiments, some of the operations can be added, skipped, omitted, or modified without departing from the scope of the embodiment.

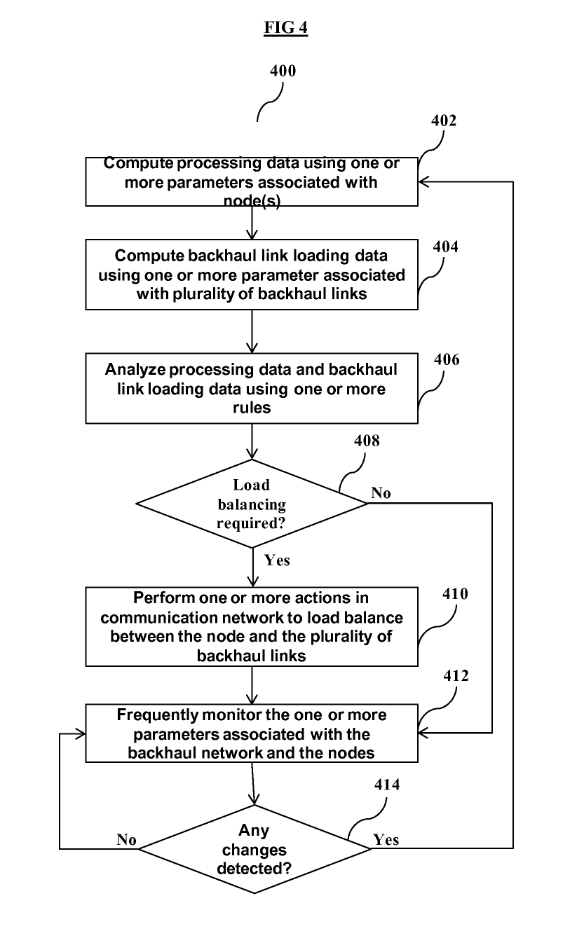

FIG. 4 illustrates a flow chart illustrating a method 400 for balancing load over between the nodes 104 and the plurality of backhaul links 106 over the communication network, according to embodiments disclosed herein. The method 400 and other description described herein provide a basis for a control program which can be implemented using a microcontroller, micro processor, or a combination thereof.

In an embodiment, at step 402, the method 400 includes computing processing data of node(s) 104 using the one or more parameters associated with the node 104. The processing data can include the overall raw data transferred by the nodes 104 using the backhaul links 106 to the server 102. In an example, the method 400 allows the server 102 to receive the parameters associated with the nodes 104. Each node 104 in the communication network can be associated with a number of corresponding parameters that can be tuned to affect the load balance, performance and responsiveness of the system 100. The one or more parameters associated with the node 104 can include for example, but not limited to, node pre-processing data, node characteristics, node transfer rate, processor loading, node near-by nodes, communication channel, profile data, node preferences, usage data, range, speed, bandwidth, security data, congestion, and the like. Further, the method 400 allows the server 102 to compute the processing data using the one or more parameters associated with the node 104.

In an embodiment, at step 404, the method 400 includes computing backhaul link loading data using one or more parameter associated with the plurality of backhaul links 106. The backhaul link loading data can be the data related to the backhaul links utilization, quality, pre-processing, loading and the like. In an example, the method 400 allows the server 102 to receive one or more parameter associated with the plurality of backhaul links 106. Each backhaul link 106 in the communication network can be associated with a number of corresponding parameters that can be tuned to affect the load balance, performance, and responsiveness of the system 100. The one or more parameters associated with the backhaul link 106 can include for example, but not limited to, link utilization data, link quality data, type of link data, link transfer rate, security data, congestion on link, and the like. Any changes in these parameters can affect the overall load balance, performance, sensitivity, cost, and reliability of the system 100.

In an embodiment, at step 406, the method 400 includes analyzing the processing data and the backhaul link loading data using one or more rules. In an example, the method 400 allows the server 102 to construct a load balancing analysis rule, such as to determine whether the load balancing is required between the node 104 and the plurality of backhaul links 106. The method 400 allows the server 102 to dynamically construct the load balancing rule using the parameters associated with the node 104 and the backhaul link 106. Further, the method 400 allows the server 102 to run or execute the load balancing rule on the processing data and the backhaul link loading data, such to perform a load balancing analysis.

In an embodiment, at step 408, the method 400 includes determining whether the load balancing is required between the node 104 and the plurality of backhaul links 106. In an embodiment, at step 410, the method 400 includes performing one or more actions in the communication network to balance the load between the node 104 and the plurality of backhaul links 106 in response to determining that the load balancing is required. The one or more actions described herein can include for example, but, not limited to, switch among the plurality of backhaul links 106 in accordance to the rules, return payload data from the node 104 by un-processed signals at each node, and the like. In an example, the method 400 allows the server 102 to effectively balance the load between the nodes 104 and the plurality of backhaul links 106 by selecting optimal action based in accordance to the rules, such as to achieve an optimal balance between the data processed in the nodes 104 and the data being sent through the backhaul links 106 to the server 102. Furthermore, the method 400 allows the nodes 104 to dynamically switch and utilize the good quality backhaul links 106 such that more data could be passed directly to the server 102.

In an embodiment, at step 412, the method 400 includes frequently monitoring the parameters associated with the nodes 104 and the backhaul links 106. In an example, the method allows the server 102 to frequently monitor the parameters and automatically load balance between the between the node 104 and the plurality of backhaul links 106 over the communication network. The frequent monitoring of the parameters can allow the server 102 to provide seamless, optimal, personalized, reliable, uninterrupted, and enhanced load balancing service in the communication network. The method 400 allows the server 102 to dynamically provide seamless balancing between the nodes 104 and the backhaul links 106 by allowing the nodes to dynamically switch among the most optimal backhaul links 106 without interrupting the service provided by the server 102.

In an embodiment, at step 414, the method 400 includes determining whether any changes detected the parameters associated with the nodes 104 and the backhaul links 106. Any changes in the parameters can affect the load balance, performance, sensitivity, cost, and reliability of the server 102. In an embodiment, upon detecting any changes in the parameters, the method 400 includes repeating the steps 402 through 414 such as to manage seamless and uninterrupted load balancing service throughout the communication network.

Furthermore, in an embodiment, the method 400 allows the server 102 to dynamically detect and update the applications associated with each node in the communication network. The method 400 allows the server 102 to automatically install and update the existing applications on the nodes 104. In an example, the existing application may be edited or new instructions may be inserted in the existing application program to update the existing applications. Further, the method 400 allows the server 102 to automatically restart the node to activate the new updates or the method allows the server 102 to configure the updates in way to get activated automatically after installation. In another embodiment, the method 400 allows the server 102 to dynamically detect and upgrade the applications associated with each node in the communication network. The method 400 allows the server 102 to automatically install different versions of application on the nodes 104. The new version application can be installed as a standalone application thereby retaining the existing applications unchanged. The new version application can be considered as a latest version and included in trend of application versions available on each node.

The various steps, acts, blocks, units, and actions of the method 400 may be performed in the order presented, in a different order or simultaneously. Further, in some embodiments, some steps, acts, blocks, units, and actions listed in the FIG. 4 may be omitted, added, or skipped without departing from the scope of the embodiment.

The embodiments disclosed herein can be implemented through at least one software program running on at least one hardware device and performing network management functions to control the network elements. The network elements shown in FIG. 1 include blocks which can be at least one of a hardware device, or a combination of hardware device and software module.

The embodiment disclosed herein specifies a system for load balancing between nodes pre-processing and backhaul utilization in a communication network. The system includes a rule engine configured to thereon to analyze different parameters associated with the nodes and backhaul links, such as to efficiently balance the load based on the requirements of each node in the network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for load balancing between at least one node and a plurality of backhaul links over a communication network, the method comprising:
computing a processing data of said at least one node using at least one parameter associated with said at least one node;
computing a backhaul link loading data using at least one parameter associated with said plurality of backhaul links;
analyzing said processing data and said backhaul link loading data using at least one rule;
determining whether load balancing is required in accordance to said analysis; and
performing at least one action in said communication network to load balance between said at least one node and said plurality of backhaul links in response to determining that said load balancing is required.

2. The method of claim 1, wherein said communication network is served by a plurality of network paths between said at least one node and a server, wherein said each network path include said plurality of backhaul links.

3. The method of claim 1, wherein said at least one parameter associated with said at least one node comprises at least one of pre-processing data, node characteristics, node transfer rate, processor loading, node near-by nodes, communication channel, profile data, node preferences, usage data, range, speed, bandwidth, security data, and congestion.

4. The method of claim 1, wherein said at least one parameter associated with said backhaul link comprises at least one of link utilization data, link quality data, type of link data, link transfer rate, security data, and congestion on link.

5. The method of claim 1, wherein analyzing said processing data and said backhaul link loading data using said at least one rule comprises:
constructing said at least one rule using said at least one parameter associated with said at least one node and said at least one parameter associated with said plurality of backhaul links;
running said at least one constructed rule on said processing data and said backhaul link; and
performing a load balancing analysis at said server in accordance to said at least one rule.

6. The method of claim 1, wherein performing said at least one action in said communication network to load balance between said at least one node and said plurality of backhaul links comprises allowing said at least one node to switch among said plurality of backhaul links in accordance to said at least one rule.

7. The method of claim 1, wherein performing said at least one action in said communication network to load balance between said at least one node and said plurality of backhaul links comprises returning payload data from said at least one node.

8. The method of claim 7, wherein said payload data is returned by processing un-processed signals at each node.

9. The method of claim 1, wherein said method further comprises receiving said at least one parameter associated with said at least one node.

10. The method of claim 1, wherein said method further comprises receiving said at least one parameter associated with said plurality of backhaul links.

11. The method of claim 1, wherein said method further comprises constantly monitoring said at least one parameter associated with said at least one node in said communication network.

12. The method of claim 11, dynamically performing load balancing in said communication network based on said monitoring.

13. The method of claim 1, wherein said method further comprises constantly monitoring said at least one parameter associated with said plurality of backhaul links in said communication network.

14. The method of claim 13, dynamically performing load balancing in said communication network based on said monitoring.

15. The method of claim 1, wherein said further comprises dynamically updating at least one application in said at least one node in said communication network.

16. The method of claim 1, wherein said further comprises dynamically versioning said at least one application in said at least one node in said communication network.

17. A system for load balancing between at least one node and a plurality of backhaul links over a communication network, the system comprising a server configured to:
compute processing data of said at least one node using at least one parameter associated with said at least one node,
compute backhaul link loading data using at least one parameter associated with said plurality of backhaul links,
analyze said processing data and said backhaul link loading data using at least one rule,
determine whether load balancing is required in accordance to said analysis, and
perform at least one action in said communication network to load balance between said at least one node and said plurality of backhaul links in response to determining that said load balancing is required.

18. The system of claim 17, wherein said communication network is served by a plurality of network paths between said at least one node and said server, wherein said each network path include said plurality of backhaul links.

19. The system of claim 17, wherein said at least one parameter associated with said at least one node comprises at least one of pre-processing data, node characteristics, node transfer rate, processor loading, node near-by nodes, communication channel, profile data, node preferences, usage data, range, speed, bandwidth, security data, and congestion.

20. The system of claim 17, wherein said at least one parameter associated with said backhaul link comprises at least one of link utilization data, link quality data, type of link data, link transfer rate, security data, and congestion on link.

21. The system of claim 17, wherein said analysis of said processing data and said backhaul link loading data using said at least one rule comprises:
construct said at least one rule using said at least one parameter associated with said at least one node and said at least one parameter associated with said plurality of backhaul links,
run said at least one rule on said processing data and said backhaul link, and
perform a load balancing analysis at said server in accordance to said at least one rule.

22. The system of claim 17, wherein performing said at least one action in said communication network to load balance between said at least one node and said plurality of backhaul links comprises allow said at least one node to switch among said plurality of backhaul links in accordance to said at least one rule.

23. The system of claim 17, wherein performing said at least one action in said communication network to load balance between said at least one node and said plurality of backhaul links comprises return payload data from said at least one node.

24. The system of claim 23, wherein said payload data is returned by processing un-processed signals at each node.

25. The system of claim 17, wherein said server is further configured to receive said at least one parameter associated with said at least one node.

26. The system of claim 17, wherein said server is further configured to receive said at least one parameter associated with said plurality of backhaul links.

27. The system of claim 17, wherein said server is further configured to constantly monitor said at least one parameter associated with said at least one node in said communication network.

28. The system of claim 27, dynamically performing load balancing in said communication network based on said monitoring.

29. The system of claim 17, wherein said server is further configured to constantly monitor said at least one parameter associated with said plurality of backhaul links in said communication network.

30. The system of claim 29, dynamically performing load balancing in said communication network based on said monitoring.

31. The system of claim 17, wherein said server is further configured to dynamically update at least one application in said at least one node in said communication network.

32. The system of claim 17, wherein said server is further configured to dynamically version said at least one application in said at least one node in said communication network.

33. A computer program product for load balancing between at least one node and a plurality of backhaul links over a communication network, the product comprising:
an integrated circuit comprising at least one processor;
at least one memory having a computer program code within said circuit, wherein said at least one memory and said computer program code with said at least one processor cause said product to:
compute processing data of said at least one node using at least one parameter associated with said at least one node,
compute backhaul link loading data using at least one parameter associated with said plurality of backhaul links,
analyze said processing data and said backhaul link loading data using at least one rule,
determine whether load balancing is required in accordance to said analysis, and
perform at least one action in said communication network to load balance between said at least one node and said plurality of backhaul links in response to determining that said load balancing is required.

34. The computer program product of claim 33, wherein said communication network is served by a plurality of network paths between said at least one node and a server, wherein said each network path include said plurality of backhaul links.

35. The computer program product of claim 33, wherein analysis of said processing data and said backhaul link loading data using said at least one rule comprises:
construct said at least one rule using said at least one parameter associated with said at least one node and said at least one parameter associated with said plurality of backhaul links,
run said at least one rule on said processing data and said backhaul link, and
perform a load balancing analysis at said server in accordance to said at least one rule.

36. The computer program product of claim 33, wherein performing said at least one action in said communication network to load balance between said at least one node and said plurality of backhaul links comprises allow said at least one node to switch among said plurality of backhaul links in accordance to said at least one rule.

37. The computer program product of claim 33, wherein performing said at least one action in said communication network to load balance between said at least one node and said plurality of backhaul links comprises return payload data from said at least one node.

38. The computer program product of claim 37, wherein said payload data is returned by processing un-processed signals at each node.

39. The computer program product of claim 33, wherein said at least one parameter associated with said at least one node comprises at least one of pre-processing data, node characteristics, node transfer rate, processor loading, node near-by nodes, communication channel, profile data, node preferences, usage data, range, speed, bandwidth, security data, and congestion.

40. The computer program product of claim 33, wherein said at least one parameter associated with said backhaul link comprises at least one of link utilization data, link quality data, type of link data, link transfer rate, security data, and congestion on link.
